(19) United States
(12) Patent Application Publication
(10) Pub. No.: US 2023/0240327 A1
(43) Pub. Date: Aug. 3, 2023

(54) FUNCTIONAL SOYBEAN MEAL

(71) Applicant: CAN TECHNOLOGIES, INC., Wayzata, MN (US)

(72) Inventor: Helio Haruo USHIJIMA, Campinas (BR)

(73) Assignee: Cargill, Incorporated, Wayzata, MN (US)

(21) Appl. No.: 17/999,736

(22) PCT Filed: May 18, 2021
(86) PCT No.: PCT/US2021/032960

§ 371 Date: Nov. 23, 2022

(30) Foreign Application Priority Data
May 29, 2020 (US) 63032481

(51) Int. Cl. A23K 10/30; A23K 20/158; A23K 20/105; A23K 20/121; A23K 40/10

(52) U.S. Cl. CPC A23K 10/30; A23K 20/105; A23K 20/121; A23K 20/158; A23K 40/10

(57) ABSTRACT

A functional soybean meal includes soybean meal and a functional additive that includes a phytogenic feed additive, a medium-chain fatty acid, an organic acid, or a combination thereof. Also provided are animal feeds and animal feed products including the functional soybean meal, methods of feeding an animal the functional soybean meal, and methods of making the functional soybean meal.

### CROSS-REFERENCE TO RELATED APPLICATIONS

This application claims the benefit of U.S. Provisional Application No. 63/032,481, filed May 29, 2020, and entitled “FUNCTIONAL SOYBEAN MEAL,” which is incorporated by reference herein in its entirety.

### BACKGROUND

A main objective of technologies applied to animal production is to obtain maximum financial performance and at the same time to produce safe and healthy food. Throughout the productive chain (e.g., genetics, nutrition, management, and health) there is a persistent search for alternatives to improve the conversion productivity with no harm to zootechnical performance and to reduce production costs.

The use of antimicrobial (e.g., antibiotic, antiviral, antiprotozoal, antifungal) and chemical feed additives in the diet as performance enhancers is an approach that has been adopted for a long time as an option to improve the performance and productivity of feed conversion. These additives derive from fungi or bacteria like avilamycin, colistin, tylosin, tiamulin, lincomycin, bacitracin, virginiamycin, flavomycin combined with other synthetic compounds. According to studies, the antimicrobial agents act as growth promoters or pro-nutrients to prevent, reduce, and control agents that are harmful to the digestive process, and are useful to improve performance.

However, derivatives like beef, milk, and eggs produced with these antimicrobials may result in the proliferation of resistant microorganisms and the presence of residues in food. The presence of antimicrobial or chemical residues in animal products used for human consumption may cause allergic reactions, toxicity or induction of bacterial resistance. In view of these risks, there is a growing concern on the use of subclinical doses of antibiotics in animal feed due to the risk of residues in animal derivatives. Based on the trends in consumption of healthy and residue-free products, the use of antimicrobials is becoming increasingly restricted and a wide variety of antimicrobials tend to be banned from various markets. In 1998, the European Union has banned the use of some antimicrobial agents as pro-nutrients, including spiramycin, tylosin phosphate, virginiamycin, and bacitracin-zinc and released only monensin, salinomycin, avilamycin, and flavomicyn. In 2007, nearly all antibiotics used as pro-nutrients were banned (including monensin, salinomycin, avilamycin, and flavomicyn) and since 2008 no antimicrobial agent has been used for this purpose in the EU.

In spite of the drastic reduction of the portfolio of antimicrobials allowed for use in animal feed as growth promoters, these substances are still being employed because of their positive results on feed efficiency and reduction of mortality rate, and because reduction or elimination of antimicrobials in the diet of production animals can increase production costs in subclinical control, reduce nutrient efficiency, and increase the use of antimicrobials for therapeutic purposes.

### SUMMARY OF THE INVENTION

Various aspects of the present invention provide a composition that is an animal feed or an animal feed product for forming the animal feed. The composition includes a functional soybean meal. The functional soybean meal includes soybean meal. The functional soybean meal also includes a functional additive that includes a phytogenic feed additive, a medium-chain fatty acid, an organic acid, or a combination thereof.

Various aspects of the present invention provide an animal feed product that is a premix, a base mix, a concentrate, a supplement, or a top dress, for forming an animal feed. The feed product includes a functional soybean meal that is 50 wt% to 100 wt% of the feed product. The functional soybean meal includes soybean meal that is 75 wt% to 99.99 wt% of the functional soybean meal. The functional soybean meal also includes a functional additive that includes a phytogenic feed additive, a medium-chain fatty acid, an organic acid, or a combination thereof. The functional additive is 0.01 wt% to 25 wt% of the functional soybean meal. The animal feed product is formulated to form the animal feed by combining with a base animal feed such that the animal feed product is 30 wt% or less of the animal feed. The functional soybean meal includes functional soybean meal particles that each include both the soybean meal and the functional additive within the particle. The functional soybean meal is substantially free of non-plant-derived antimicrobials

Various aspects of the present invention provide an animal feed. The animal feed includes a base animal feed. The animal feed also includes a functional soybean meal that is 1 wt% to 20 wt% of the animal feed. The functional soybean meal includes soybean meal that is 75 wt% to 99.99 wt% of the functional soybean meal. The functional soybean meal also includes a functional additive including a phytogenic feed additive, a medium-chain fatty acid, an organic acid, or a combination thereof, wherein the functional additive is 0.01 wt% to 25 wt% of the functional soybean meal. The functional soybean meal includes functional soybean meal particles that each include both the soybean meal and the functional additive within the particle. The animal feed is substantially free of non-plant-derived antimicrobials. The animal feed is a complete feed.

Various aspects of the present invention provide a method of feeding an animal. The method includes feeding a composition that is an animal feed or an animal feed product to an animal. The composition includes a functional soybean meal. The functional soybean meal includes soybean meal. The functional soybean meal also includes a functional additive that includes a phytogenic feed additive, a medium-chain fatty acid, an organic acid, or a combination thereof.

Various aspects of the present invention provide a method of feeding an animal. The method includes feeding the animal a functional soybean meal. The functional soybean meal includes soybean meal that is 75 wt% to 99.99 wt% of the functional soybean meal. The functional soybean meal includes a functional additive that includes a phytogenic feed additive, a medium-chain fatty acid, an organic acid, or a combination thereof. The functional additive is 0.01 wt% to 25 wt% of the functional soybean meal. The functional soybean meal includes functional soybean meal particles that each include both the soybean meal and the functional additive within the particle.

Various aspects of the present invention provide a method of feeding an animal. The method includes feeding the animal an animal feed including a base animal feed. The animal feed also includes a functional soybean meal that is 1 wt% to 20 wt% of the animal feed. The functional soybean meal includes soybean meal that is 75 wt% to 99.99 wt% of the functional soybean meal. The functional soybean meal also includes a functional additive that includes a phytogenic feed additive, a medium-chain fatty acid, an organic acid, or a combination thereof. The functional additive is 0.01 wt% to 25 wt% of the functional soybean meal. The functional soybean meal includes functional soybean meal particles that each include both the soybean meal and the functional additive within the particle. The animal feed is substantially free of non-plant-derived antimicrobials.

Various aspects of the present invention provide a method of making a composition that is an animal feed or an animal feed product, wherein the animal feed or animal feed product includes a functional soybean meal. The method includes combining soybean meal and functional additives to form the functional soybean meal.

Various aspects of the present invention provide a method making a composition that is an animal feed and that includes a functional soybean meal. The method includes combining functional soybean meal with a base animal feed to form the animal feed.

Various aspects of the present invention provide a method of making a functional soybean meal. The method includes combining a functional additive with a soybean meal during the milling of soybeans to form the soybean meal and prior to the drying of the soybean meal, to form the functional soybean meal. The functional soybean meal includes the soybean meal that is 75 wt% to 99.99 wt% of the functional soybean meal. The functional soybean meal also includes the functional additive including a phytogenic feed additive, a medium-chain fatty acid, an organic acid, or a combination thereof. The functional additive is 0.01 wt% to 25 wt% of the functional soybean meal. The functional soybean meal includes functional soybean meal particles that each include both the soybean meal and the functional additive within the particle. The functional soybean meal is substantially free of non-plant-derived antimicrobials

In various embodiments, the functional soybean meal of the present invention and methods of feeding an animal the same have certain advantages over other soybean meals and animal feeds including the same. There is a huge need for a transition from a preventive use of antibiotics in animals to a responsible therapeutic use of antibiotics. The functional soybean meal of the present invention, compositions including the same, and methods of feeding an animal the same, can be an alternative to reduce preventative use of antibiotics in a responsible way, without compromising food safety and human health as well as animal health, welfare, and productivity. For example, in various embodiments, the functional soybean meal of the present invention and/or the animal feed or animal feed product including the same has antimicrobial properties and is substantially free of non-plant-derived antimicrobials. In various embodiments, the functional soybean meal of the present invention can allow reduction or elimination of non-plant-derived antimicrobials in an animal’s diet without or with a reduction of the negative effects typically encountered when removing non-plant-derived antimicrobials from the diet.

Some species have a preference to eat protein (e.g., soybean and corn) while refusing other materials (e.g. additives, nutrients and vitamins), impacting the growth performance and increasing losses of food. In various embodiments, the functional soybean meal of the present invention includes functional soybean meal particles that each include both the soybean meal and the functional additive within the particle, which can eliminate problems of selective intake by the animal. Including both the soybean meal and the functional additive in the particle can help to avoid losses during processing, transport, and storage, prior to reaching the consumer.

In various embodiments, the functional soybean meal of the present invention and methods of feeding an animal the same can provide benefits for an animal including digestive enhancement (e.g., more complete digestion of food and/or less negative digestive effects from food), improved palatability, improved nutrient utilization, improved gut health, reduction of bacterial pathogenicity, improvement in performance, improved well-being, reduced inflammation, overall improved health, overall improvement in performance, or a combination thereof. In various embodiments, different species of animals, and animals in different phases of life, can express the benefits of the functional soybean meal differently or to different extents.

### DETAILED DESCRIPTION OF THE INVENTION

Reference will now be made in detail to certain embodiments of the disclosed subject matter. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” or “at least one of A or B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in any order without departing from the principles of the invention, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%. The term “substantially free of” as used herein can mean having none or having a trivial amount of, such that the amount of material present does not affect the material properties of the composition including the material, such that about 0 wt% to about 5 wt% of the composition is the material, or about 0 wt% to about 1 wt%, or about 5 wt% or less, or less than or equal to about 4.5 wt%, 4, 3.5, 3, 2.5, 2, 1.5, 1, 0.9, 0.8, 0.7, 0.6, 0.5, 0.4, 0.3, 0.2, 0.1, 0.01, or about 0.001 wt% or less, or about 0 wt%.

### Composition That Is an Animal Feed or an Animal Feed Product for Forming the Animal Feed

Various aspects of the present invention provide a composition that is an animal feed or an animal feed product for forming the animal feed. The composition includes a functional soybean meal. The functional soybean meal can include a soybean meal and a functional additive that includes a phytogenic feed additive, a medium-chain fatty acid, an organic acid, or a combination thereof.

The functional soybean meal can include functional soybean meal particles. The functional soybean meal particles can be formed by combining the soybean meal as is it being milled from soybeans with the functional additive, before the soybean meal is dried. Each of the functional soybean meal particles can include both the soybean meal and the functional additive, such as within the particle (e.g. not merely contacting the particle on the exterior, but part of the particle itself). The soybean meal and functional additive can be homogeneously distributed across the particles, such that each of the functional soybean meal particles includes an approximately equal concentration of the soybean meal and an approximately equal concentration of the functional additive. The soybean meal and the functional additive can be homogeneously distributed in each functional soybean meal particle. The functional soybean meal can be substantially free of particles that include the functional additive but that are free of the soybean meal. The functional soybean meal can be substantially free of particles that include the soybean meal but are free of the functional additive. By including both the soybean meal and the functional additive in each particle, selective intake by the animal can be avoided. The functional soybean meal can have any particle size suitable for ingestion by the intended animal, such as an weight average particle size of 0.1 mm to 50 mm, or 0.1 mm or more but less than or equal to 50 mm, or 0.1 mm to 50 mm and less than, equal to, or greater than 1 mm, 2, 4, 6, 8, 10, 12, 15, 20, 25, 30, 35, 40, 45 mm, or 50 mm or less. Particle size of non-spherical particles can be the largest dimension of the particle.

Soybean meal is an important source of protein for animals due to its excellent amino acid composition and high level of digestibility. As soybean meal is the main source of protein for the feed industry worldwide, it is strategically traded around the globe every day of the year. Feed manufacturers use soybean meal as the standard against which other protein sources are compared. Soybean meal has also become the protein source that determines the price of proteins for livestock feeding. Soybean meal is universally accepted as the most important protein ingredient in animal diets. Soybean meal dominates the market for protein supplements for swine and poultry. There are a number of reasons for this, including its consistency in nutrient content, its ready availability year-round, and its high content of crude protein. Because many animal producers focus on high-energy diets, soybean meal is of superior value because no common plant protein feedstuff exceeds soybean meal in digestible energy content.

The soybean meal in the functional soybean meal can be any suitable soybean meal (e.g., meal formed from glycine max). The soybean meal can be ground, expelled, solvent extracted, otherwise processed for animal consumption, or a combination thereof. The soybean meal can include or can be soybean meal, such as ground soybean cake, ground soybean chips, ground soybean flakes, or a combination thereof. The soybean meal can be any suitable proportion of the functional soybean meal, such as 50 wt% to 99.999 wt% of the functional soybean meal, 75 wt% to 99.99 wt%, 85 wt% to 99.99 wt%, or greater than 50 wt% but less than or equal to 99.999 wt%, or 50 wt% to 99.999 wt% and less than, equal to, or less than 52 wt%, 54, 56, 58, 60, 62, 64, 66, 68, 70, 72, 74, 75, 76, 78, 80, 82, 84, 86, 88, 90, 92, 94, 95, 96, 97, 98, 99, 99.9, 99.99 wt%, or 99.999 wt% or less.

The phytogenic feed additive, the medium-chain fatty acid, the organic acid, or a combination thereof, can include or can be a plant-derived antimicrobial agent (e.g., antibacterial, antifungal, antiviral, antiprotozoal, antiparasitic, or a combination thereof). The phytogenic feed additive, the medium-chain fatty acid, the organic acid, or a combination thereof, can include or can be an antioxidant, prebiotic, probiotic, ionophore, or a combination thereof. The phytogenic feed additive, the medium-chain fatty acid, the organic acid, the functional soybean meal, the composition including the functional soybean meal, or a combination thereof, can be 100 wt% plant derived and/or can be substantially free of non-plant-derived materials such as non-plant-derived antimicrobial agents or non-plant-derived antibiotics.

The functional soybean meal can be substantially free of non-plant-derived antimicrobials, or substantially free of non-plant-derived antibiotics. The composition (e.g., the animal feed, the animal feed product, or both) can be substantially free of non-plant-derived antimicrobials, or substantially free of non-plant-derived antibiotics. In other aspects, the functional soybean meal of the composition including the same can include one or more non-plant-derived antimicrobials or non-plant-derived antibiotics.

The functional additive can include a phytogenic feed additive. A phytogenic feed additive can include plant-derived substances, such as bioactive plant-derived substances, such as essential oils, herbs, spices, or a combination thereof. Phytogenic feed additives can have antioxidant activity, can modulate intestinal microbiota, improve digestibility, improve absorption of nutrients, and can increase immunity. The phytogenic feed additive can include a plant-extract. The phytogenic feed additive can include a plant-derived essential oil, a saponin, a flavonoid, a mucilage, a tannin, or a combination thereof. The phytogenic feed additive can include a plant-derived essential oil derived from thyme (thymus vulgaris 1., lamiaceae), ajowan (trachyspermum ammi), oregano (origanum syriacum), clove (syzygium aromaticum), lavender (lavandula angustifólia and/or lavandula stoechas), eucalyptus (eucalyptus citriodora, eucalyptus radiata, eucalyptus globulus and/or eucalyptus polybractea), marjoran (origanum majorana), peppermint (mentha arvenses and/or mentha piperita), ho wood (cinnamonum camphora), palma rosa (cymbopogon martini), cinnamon (cinnamonum verum, cinnamon cassia and/or cinnamon loureiroi), cumin (cuminum cyminum), niaouli (melaleuca quinquenervia), tea tree (leptospermum petersonii), lemon grass (cymbopogon flexuosus and/or cymbopogon citratus), lemon balm (melissa officinalis), citronella (cymbopogan winterianus), myrtus (myrtus communis), rosemary (rosmarinus officialis), pennyroyal (mentha polegium), bay (laurus nobilis), basil (ocimum basilicum), anis (pimpinella anisum), star aniseed (illicium verum), fennel (foeniculum vulgare), rose geranium (pelargonium graveolens), ylang ylang (cananga adorate), chamomile (chamaemelum nobile), birch (betula alleghaniensis and/or betula lenta), african basil (ocimum gratissimum), coriander (coriandrum sativum), bitter orange (citrus aurantium), silver fir (abies alba), hop (humulus lupulus), marijuana (cannabis sativa), ginger (zingiber officiale), myrrh (commiphora myrrha), black pepper (piper nigrum), bergamot orange (citrus bergamia), lemon (citrus limon, citrus aurantifolia, citrus reticulata and/or citrus bergamia), angelica (angelia archangelica), patchouli (pogostemon cablin), damask rose (rosa damascena), celery (apium graveolens), garlic (allium sativum), cedar (cedrus deodora), or a combination thereof. The phytogenic feed additive can include an aromatic phenol, terpenic alcohol, sesquiterpenic alcohol, aromatic aldehyde, terpenic aldehyde, terpenic ketone, terpenic oxide, methyl ether phenol, terpenic sterol, terpene, sesquiterpene, lactone, coumarin, a phthalide, or a combination thereof. The phytogenic feed additive can be any suitable proportion of the functional soybean meal, such as 0.001 wt% to 5 wt% of the functional soybean meal, 0.01 wt% to 2 wt%, or greater than 0.001 wt% but less than or equal to 5 wt%, or 0.001 wt% to 5 wt% and less than, equal to, or greater than 0.01 wt%, 0.1, 0.5, 1, 1.5, 2, 2.5, 3, 3.5, 4, 4.5 wt%, or 5 wt% or less.

Essential oils are a complex mixture of volatile lipophilic substances with low molecular weight, usually odoriferous and liquid, including mostly molecules of terpenic nature. They can have a pleasant and striking scent and are often extracted from vegetal materials using steam distillation, distillation, or cold pressing. Plant essential oils have been shown to have activity against many species of bacteria: Aromonas hydrophila, Listeria monocytogenes, Clotridium botulinum, Enterococcus faecalis, Staphylococcus spp, Bacillus spp., Enterobacteriaceae, Campylobacter jejuni, Vibrio para-haemolyticus, Pseudomonas spp, Bacillus cereus, Shigella spp., Salmonella spp, Escherichia coli, and many others, Gram-positive or Gram-negative, aerobic or non-aerobic. Table 1 shows the antimicrobial and anti-inflammatory effects of some essential oil compounds.

TABLE 1

Antimicrobial and anti-inflammatory effects of some compounds from essential oils

| | | | | | |
|---|---|---|---|---|---|
| Biological effects | Aromatic phenols | Terpenic alcohols | Aromatic aldehydes | Terpenic aldehydes | Terpenic ketones |
| Antibacterial | ++++ | +++ | ++++ | ++ | - |
| Antiviral | +++ | +++ | +++ | +++ | ++++ |
| Antifungal | +++ | +++ | +++ | ++ | - |
| Antiparasite | ++++ | - | +++ | - | ++++ |
| Anti-inflamatory | - | - | - | ++++ | - |

The possible mechanisms of essential oil action in the animal body may include digestion stimulation, changes in the intestinal microbiota, increased digestibility and absorption of nutrients, and antimicrobial and immunomodulatory effects. The antimicrobial effect of an essential oil can be associated with the change in permeability and integrity of the bacterial cell membrane; with the relation between the current active chemical structure and its antimicrobial effect; with the class of the microorganism tested (e.g., to its cellular membrane characteristics); or a combination thereof. Table 2 shows some typical compounds from essential oils.

TABLE 2

Typical compounds from essential oils

| | | | | |
|---|---|---|---|---|
| Aromatic phenols | Terpenic alcohols | Aromatic aldehydes | Terpenic aldehydes | Terpenic ketones |
| Thymol | Linalool | Cinnamaldehyde | Citral | Methone |
| Carvacrol | Geraniol | Cuminaldehyde | Geranial | Borneone |
| Eugenol | Tuianol | Felandral | Citronellal | Piperitone |
| Guaiacol | Citronellol | Benzaldehyde | Myrtenal | Carvone |
| Australol | Menthol | Anisaldehyde | Anisial | Pinecarvone |

According to several studies, essential oils such as thymol, carvacrol, eugenol, geraniol, among others, have an antimicrobial activity stronger than in some antibiotics. These substances act against microorganisms through a lipophilic process on the cell membrane, spreading the polypeptide chains that will constitute the cell membrane matrix. They act by changing the permeability and activity of the bacteria cell membrane. This damage to the enzymatic system of the bacteria is related to the production of energy and synthesis of structural components. Table 3 shows some combinations of essential oil compounds. Table 3 refers to possible or potential combinations functional actives (thymol, carvacrol, eugenol, etc.) as examples of synergic combinations for antimicrobial, antiviral, antibacterial and antiparasitic effects.

TABLE 3

Combinations of essential oil compounds

| Type of composition | Compounds that may be present | | | | |
|---|---|---|---|---|---|
| | F1 | F2 | F3 | F4 | F5 |
| Aromatic phenol 100% | Thymol | Carvacrol | Eugenol | Guaiacol | Australol |
| Aromatic phenol (70%) + | Thymol | Carvacrol | Lianool | Citronellol | Menthol |
| Terpenic aldehyde (30%) | | | | | |
| Aromatic aldehyde 100% | Cinnamaldehyde | Cuminaldehyde | Felandral | Benzaldehyde | Anisaldehyde |
| Aromatic phenol (70%) + | Cinnamaldehyde | Cuminaldehyde | Menthone | Borneone | Carvone |
| Terpenic ketone (30%) | | | | | |
| Terpenic aldehyde 100% | Citral | Geranial | Citronellal | Myrtenal | Anisial |
| Aromatic phenol (50%) + | Thymol | Carvacrol | Citral | Citronellal | Menthone |
| Terpenic aldehyde (25%) + | | | | | |
| Terpenic ketone (25%) | | | | | |

The functional additive can include an organic acid. The organic acid can be any suitable organic acid. In some aspects, the organic acid is not a medium-chain fatty acid (e.g., the organic acid can have a carbon length of less than 6, or the organic acid can include unsaturated bonds). The organic acid can be a C₂-C₆ or C₂-C₅ saturated or unsaturated mono- or di-carboxylic acid optionally substituted with one or more hydroxyl groups. The organic acid can include lactic acid, benzoic acid, fumaric acid, acetic acid, propionic acid, butyric acid, citric acid, malic acid, sorbic acid, formic acid, or a combination thereof. The organic acid can be any suitable proportion of the functional soybean meal, 0.001 wt% to 30 wt% of the functional soybean meal, 0.01 wt% to 15 wt%, or greater than 0.001 wt% but less than or equal to 30 wt%, or 0.001 wt% to 30 wt% and less than, equal to, or greater than 0.01 wt%, 0.1, 0.5, 1, 2, 3, 4, 5, 6, 7, 8, 9, 10, 11, 12, 13, 14, 15, 16, 18, 20, 22, 24, 26, 28 wt%, or 30 wt% or less.

Organic acids can reduce digestive tract pH, inhibiting the development of pathogens which and sensitive to acidic pH and favoring microorganisms with beneficial action on the host through. Table 4 lists several organic acids along with pKa and aqueous solubility.

TABLE 4

Solubility and pKa for several organic acids

| Organic acid | pKa | Aqueous solubility |
|---|---|---|
| Formic acid | 3.75 | +++ |
| Acetic acid | 4.76 | +++ |
| Propionic acid | 4.88 | +++ |
| Lactic acid | 3.83 | ++ |
| Citric acid | 3.13 | ++ |
| Caproic acid | 4.88 | - |
| Caprylic acid | 4.89 | - |

Organic acids are substances that contain a carboxylic acid in the molecule and can be fatty acids, aminoacids, or many other organic substances. The organic acid in the functional soybean meal can be a short-chain volatile fatty acids, occasionally referred to as weak acids. Organic acids are an alternative to antibiotics, since they act on the microorganisms in the gastrointestinal tract of the animals. Organic acids reduce the pH of the intestinal tract, controlling the microbiota that does not grow at lower pH values.

Some acids, like the propionic, formic, sorbic, and lactic acids, have a bactericidal effect when in their dissociated form. Short-chain organic acids penetrate through the cell wall in a non-dissociated form and, in this way, reduce the pH of the cytoplasm and the inhibition of the synthesis of the DNA, RNA and other microbial molecules. In parallel to the action on the microbial population of the gastrointestinal tract, these acids can improve significantly the absorption of nutrients of the diet. Table 5 lists the inhibitory effect of some organic acids on microbial growth.

TABLE 5

The inhibitory effect of some organic acids on microbial growth

| Organic acid | Properties | | Growth inhibition | | |
|---|---|---|---|---|---|
| | Molecule | pKa | Bacteria | Yeast | Mold |
| Formic acid | HCOOH | 3.75 | ++++ | + | + |
| Lactic acid | CH₃CHOHCOOH | 3.86 | + | - | - |
| Acetic acid | CH₃COOH | 4.76 | ++ | +++ | +++ |
| Propionic acid | CH₃CH₂COOH | 4.87 | ++ | +++ | +++ |
| Citric acid | C₃H₅O(COOH) | 3.10 | ++++ | +++ | +++ |
| Sorbic acid | C₅H₅O₂ | 4.76 | +++ | ++++ | ++++ |
| Benzoic acid | C₆H₅COOH | 4.20 | +++ | ++++ | ++++ |

In various aspects, organic acids can offset insufficient production of HCl for high buffering capacity diets (high protein and macro elements). Organic acids can play a role in the metabolism of aminoacids, the synthesis of DNA, and in the energy metabolism of microorganisms.

Organic acids can reduce intracellular pH and can change cellular membrane permeability by blocking the electron transport system. Cells can react by eliminating the excess protons and by trying to maintain a constant pH-this mechanism makes the energetic expenditure higher, reducing the growth of microbial cells. Organic acids can prevent the growth of microorganisms or the development of pathogenic bacteria spores. Organic acids can act in synergy with antioxidants to preserve fat and avoid enzymatic darkening of feeds or feed products. Organic acids can act as chelators, removing and sequestering metals that cause the formation of complexes that accelerate the deterioration of color and taste. Organic acids can have a trophic action on the intestinal structure and development, improving the surface of absorption due to the increased size of the villi.

The use of organic acids for reducing animal stomach pH can aid the digestion process by reducing the burden of pathogenic microorganisms such as Escherichia coli and Salmonella spp. Table 6 lists the effect of various organic acids when used in poultry.

TABLE 6

Effect of various organic acids when used in poultry

| Organic acid | Concentration (wt% of feed) | Main effects |
|---|---|---|
| Butyric acid | 0.15 | Maintain the beneficial micro flora |
| Formic acid | 0.50 - 1.00 | Reduction of coecal pH and bactericidal effect on Salmonella. |
| Propionic acid (buffered) | 0.15 - 0.20 | Increase in dressing percentage in female broilers. |
| Fumaric acid | 0.50 - 1.00 | Improvement in weight gain of broilers. |
| Lactic acid | 2.00 | Feed to gain ratio significantly improved. Body weight gain. |
| Sorbic acid | 1.12 | Improves feed efficiency. |
| Tartaric acid | 0.33 | Improves weight gain. |
| Benzoic acid | 0.20 | Positive influence on growth. |
| Malic acid | 0.50 - 2.00 | Increase in weight gain. |

In the poultry production, acidifiers are most commonly used to promote antimicrobial action. Among the bird disorders, the most known is the coccidiose which is caused by the Eimeria parasite and causes physical damage to the intestinal epithelium, promotes proliferation of pathogens such as the Clostridium, and causes problems for the absorption of nutrients by the animal.

The functional additive can include a medium-chain fatty acid. The medium-chain fatty acid can be a C₆-C₁₂ saturated monocarboxylic acid. The medium fatty acid can include caproic acid, caprylic acid, capric acid, lauric acid, or a combination thereof. The medium-chain fatty acid can form any suitable proportion of the functional soybean meal, such as 0.001 wt% to 10 wt% of the functional soybean meal, 0.01 wt% to 5 wt%, or greater than 0.001 wt% but less than or equal to 10 wt%, or 0.001 wt% to 10 wt% and less than, equal to, or greater than 0.01 wt%, 0.1, 0.5, 1, 1.5, 2, 2.5, 3, 3.5, 4, 4.5, 5, 6, 7, 8, 9 wt%, or 10 wt% or less.

The antimicrobial mechanism of a medium-chain fatty acid can be related to the microbial cell membrane permeability to the non-dissociated fatty acid. The fatty acid can be capable of passing through the membrane of the microbial cell from the outside to the more alkaline inside. Because of the higher intracellular alkalinity, the fatty acid dissociates and decreases the intracellular pH to a level below survival. The fatty acid can act as a proton pump that increases intracellular pH levels. The acidification of the bacterial cytoplasm causes instability on the pH and induces the bacteria to try to maintain a stable pH value, consuming a lot of energy and causing its death. In addition, fatty acids can interfere with DNA replication of microbes, preventing bacteria from multiplying and inhibiting the production of microbial lipase that helps to attach microorganisms to the digestive tract walls, reducing infection pressure. Table 7 lists properties of various medium-chain fatty acids.

TABLE 7

Medium chain fatty acids properties

| Medium-chain fatty acid | Molecular weight, Da | Melting point, °C | pKa |
|---|---|---|---|
| Caproic acid | 116.20 | -3.30 | 4.88 |
| Caprylic acid | 144.20 | 16.70 | 4.89 |
| Capric acid | 172.30 | 31.90 | 4.89 |
| Lauric acid | 200.30 | 44.00 | 5.13 |

The functional additive can be any suitable proportion of the functional soybean meal, such as 0.001 wt% to 50 wt% of the functional soybean meal, 0.01 wt% to 25 wt%, 0.01 wt% to 15 wt%, or less than 0.001 wt% but less than or equal to 50 wt%, or 0.001 wt% to 50 wt% and less than, equal to, or greater than 0.01 wt%, 0.1, 0.5, 1, 2, 3, 4, 5, 6, 7, 8, 9, 10, 11, 12, 13, 14, 15, 16, 18, 20, 22, 24, 26, 28, 30, 35, 40, 45 wt%, or 50 wt% or less.

The functional soybean meal can be any suitable proportion of the composition that is an animal feed or an animal feed product for forming the animal feed, such as 0.01 wt% to 100 wt% of the composition, or greater than 0.01 wt% but less than or equal to 100 wt%, or 0.01 wt% to 100 wt% and less than, equal to, or greater than 0.1 wt%, 1, 2, 3, 4, 5, 6, 8, 10, 15, 20, 25, 30, 35, 40, 45, 50, 55, 60, 65, 70, 75, 80, 85, 90, 91, 92, 93, 94, 95, 96, 97, 98, 99, 99.9, 99.99 wt%, or 100 wt% or less.

In various aspects, the composition can be an animal feed. The functional soybean meal can form any suitable proportion of the animal feed, such as 0.1 wt% to 50 wt% of the animal feed, 1 wt% to 20 wt%, or greater than 0.1 wt% but less than or equal to 50 wt%, or 0.1 wt% to 50 wt% and less than, equal to, or greater than 1 wt%, 2, 3, 4, 5, 6, 7, 8, 9, 10, 11, 12, 13, 14, 15, 16, 17, 18, 19, 20, 22, 24, 26, 28, 30, 35, 40, 45 wt%, or 50 wt% or less. The animal feed can be formulated for use in any suitable phase of life of the animal. The animal feed can provide benefits for an animal including digestive enhancement (e.g., more complete digestion of food and/or less negative digestive effects from food), improved palatability, improved nutrient utilization, improved gut health, reduction of bacterial pathogenicity, improvement in performance, improved well-being, reduced inflammation, overall improved health, overall improvement in performance, or a combination thereof, as compared to a corresponding animal feed that is free of the functional soybean material (e.g., that is the same as the inventive method other than that the feed is free of the functional soybean material), or as compared to a corresponding animal feed that includes the soybean meal but is free of the functional additive, or that includes the soybean meal and the functional additive but wherein particles of the soybean meal do not include the functional additive and wherein particles of the functional additive do not include the soybean meal.

In some aspects, the animal feed can be a complete feed. A complete feed is a nutritionally adequate feed for animals that is compounded to be fed as the sole ration and is capable of maintaining life and/or promoting production without any additional substance being consumed except water. Complete feeds are compounded mixtures containing all the nutrients of concentrates plus various energy sources such as grains, some fat, and the like. In addition, certain major minerals may be added. An example of a complete feed can include cottonseed meal, rapeseed and canola meals, meat and bone meal, wheat middlings, soybean meal, corn gluten meal, distillers grains, blood meal, salt, macro-minerals, minerals, vitamins, and combinations thereof.

The composition including the functional soybean meal can be an animal feed product designed to be combined with one or more other components to form an animal feed, such as by combining the animal feed product with a base animal feed to form the animal feed. In some aspects, the animal feed product only includes the functional soybean meal and is free of other materials; in other aspects, the animal feed product includes one or more other components in addition to the functional soybean meal.

The animal feed product can be for forming an animal feed by combining the animal feed product with a base animal feed to form the animal feed. The base animal feed can be a commercially available feed or other animal feed. A base animal feed can refer to a ration that contains any of the various cereal grains, their by-products, and other sources of primary nutrition (e.g., fat, fiber, and protein) such as barley, blood meal, bone meal, Brewer’s grain, corn grain, corn gluten meal, corn gluten feed, cottonseed (e.g., whole or meal), distiller’s grain, fish meal, hominy, feather meal, molasses, peanut skins, soybeans (e.g., whole or meal), tallow, wheat (e.g., whole, bran or middlings), or a combination thereof. The animal feed product can be formulated to be combined with a base animal feed in any suitable proportion to form the animal feed. For example, the animal feed product can be formulated to form the animal feed by combining with a base animal feed such that the animal feed product is less than 50 wt% of the animal feed, less than 20 wt% of the animal feed, 1 wt% to 20 wt%, or less than 50 wt% and less than, equal to, or greater than 1 wt%, 2, 3, 4, 5, 6, 7, 8, 9, 10, 11, 12, 13, 14, 15, 16, 17, 18, 19, 20, 22, 24, 26, 28, 30, 35, 40, 45 wt%, or 50 wt% or less.

The animal feed product can be any suitable feed product, such as any suitable feed product designed to be combined with other components to form an animal feed (e.g, a complete animal feed). For example, the animal feed product can be premix, a concentrate, a base mix, a supplement, a top dress, or a combination thereof.

A premix is a composition that can include vitamins, minerals, appropriate medications, carriers, and combinations thereof, and are typically less than 1% of the diet but can be higher. The carrier can increase bulk to improve distribution in compounding to prepare a more complete feed material. Examples of carriers can include soy mill run, rice bran, and similar edible plant by-products. Such premixes can be used to formulate concentrates and complete feeds.

A concentrate is a composition that can include high-protein feed components and can also include vitamins, minerals, appropriate medications, and combinations thereof. A concentrate is typically 5-40% of the diet but can be higher or lower. A concentrate can include additives. Concentrates can be used to make complete feeds by adding available grains or other energy sources. An additive is an ingredient or a chemical preparation or combination of ingredients which is added to the basic feed to fulfill a specific need. It is usually used in micro quantities and may have no nutritional value but is added to the feed to improve its quality and efficacy. Feed additives include, but not limited to, acidifiers, antioxidants, aromatics, deodorizing agents, flavor enhancers, mold inhibitors, pellet binders, preservatives, sweeteners, toxin binders, and the like.

A base mix can be similar to a supplement but contain only part of the animal’s protein requirements, so is generally used with high protein ingredients and grain (e.g., ground grain and protein source, such as soybean meal) to form the animal feed. A base mix can include a mixture of one or more macro-mineral sources and one or more micro-ingredient sources such as vitamin premixes, trace mineral premixes, essential amino acids and feed additives, that when mixed with sources of protein and energy form a complete feed.

A supplement is a feed ingredient or a chemical preparation or combination of feed ingredients intended to supply the deficiencies in an animal feed and/or improve the nutritive balance or performance of the animal feed. A top dress is a supplement added at specific time intervals to the animal ration to provide a specific supplement or supplements over a period of time that makes it inconvenient or difficult to include in complete feed.

The functional soybean meal can be any suitable proportion of the animal feed product, depending on the intended proportion of the animal feed occupied by the animal feed product. For example, the functional soybean meal can be 1 wt% to 100 wt% of the animal feed product, 50 wt% to 100 wt%, or greater than 1 wt%, or 1 wt% to 100 wt% and less than, equal to, or greater than 2 wt%, 4, 6, 8, 10, 15, 20, 25, 30, 35, 40, 45, 50, 55, 60, 65, 70, 75, 80, 85, 90, 92, 94, 96, 97, 98, 99, 99.9, 99.99 wt%, or 100 wt% or less.

In various aspects, the animal feed, the animal feed product, the functional soybean meal, or a combination thereof, further includes vitamins, trace minerals, edible plant materials, grain, corn, soy, rice, wheat, or a combination thereof. Additional components of the functional soybean meal can be part of the functional soybean meal particles along with the functional additive. In some aspects, the functional soybean meal can be substantially free of materials other than the soybean meal and the functional additive, or other than the soybean meal and the phytogenic feed additive, the medium-chain fatty acid, and the organic acid. In other aspects, the functional soybean meal can include one or more components other than the soybean meal and the functional additive, or other than the soybean meal and the phytogenic feed additive, the medium-chain fatty acid, and the organic acid.

### Method of Feeding an Animal

Various aspects of the present invention provide a method of feeding an animal. The method can include feeding the animal the function soybean meal described herein. For example, the method can include feeding the animal a functional soybean meal including a soybean meal and a functional additive. The method can include feeding the animal the composition that is the animal feed composition of the animal feed product that includes the functional soybean meal.

The animal can be any suitable animal. The animal can be poultry, swine, cow (e.g., dairy cattle, beef cattle), fish, goats, a pet or companion animal (e.g., dogs, cats, birds, fish, potbelly pigs, rodents, horses, reptiles, turtles, etc.), or sheep.

The method can include feeding the animal the functional soybean meal at any suitable rate and for any suitable duration. The method can include feeding the animal a daily feed ration that includes the functional soybean meal or the composition including the same. The daily feed ration can be fed to the animal on most days or on all days.

The method can include feeding the animal an animal feed that includes the functional soybean meal. The method can further include combining the functional soybean meal or an animal feed product including the same with a base animal feed to form the animal feed; in other aspects, the functional soybean meal animal feed product including the same are already combined with a base animal feed before the onset of the method.

In various aspects, the method can provide benefits for an animal including digestive enhancement (e.g., more complete digestion of food and/or less negative digestive effects from food), improved palatability, improved nutrient utilization, improved gut health, reduction of bacterial pathogenicity, improvement in performance, improved well-being, reduced inflammation, overall improved health, overall improvement in performance, or a combination thereof, as compared to a corresponding method free of feeding the animal the functional soybean meal (e.g., that is the same as the inventive method other than that the feed is free of the functional soybean material), or as compared to a corresponding method including an animal feed that includes the soybean meal but is free of the functional additive, or that includes the soybean meal and the functional additive but wherein particles of the soybean meal do not include the functional additive and wherein particles of the functional additive do not include the soybean meal.

### Method of Making a Functional Soybean Meal

Various aspects of the present invention provide a method of forming the functional soybean meal described herein. The method can include combining the soybean meal and the functional additive to form the functional soybean meal.

The soybean meal and the functional additive can be combined in any suitable way such that an embodiment of the functional soybean meal is formed. The soybean meal and the functional additive can be combined during the milling of soybeans to form the soybean meal (e.g., in the crushing mill) and prior to the drying of the soybean meal (e.g., is not a dry blend). Combining the functional additive with the soybean meal during the milling of soybeans to form the soybean meal, prior to the drying of the soybean meal, intimately mixes the soybean meal and the functional additive to form the particles of the functional soybean meal that each include both the soybean meal and the functional additive within the particle.

In some aspects, the composition only includes the functional soybean meal (e.g., the composition can be an animal feed product for combining with a base animal feed to form an animal feed), and the method of making the functional soybean meal is a method of making the composition. In other aspects, the composition includes other components in addition to the functional soybean meal, such as a base animal feed, and/or other components.

### Method of Making a Composition That Is an Animal Feed or an Animal Feed Product for Forming the Animal Feed

Various aspects of the present invention provide a method of forming the composition described herein that is an animal feed or an animal feed product for forming the animal feed. The method can optionally include forming the functional soybean meal as described herein; in other aspects, the functional soybean meal is already formed before the onset of the method.

The method can include adding other components to the functional soybean meal to form the composition that is an animal feed or an animal feed product for forming the animal feed. For example, the method can include combining the functional soybean meal with a base animal feed to form the animal feed.

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present invention. Thus, it should be understood that although the present invention has been specifically disclosed by specific embodiments and optional features, modification and variation of the concepts herein disclosed may be resorted to by those of ordinary skill in the art, and that such modifications and variations are considered to be within the scope of embodiments of the present invention.

### Exemplary Embodiments

The following exemplary embodiments are provided, the numbering of which is not to be construed as designating levels of importance:

Embodiment 1 provides a composition that is an animal feed or an animal feed product for forming the animal feed, the composition comprising:

a functional soybean meal comprising
soybean meal; and
a functional additive comprising a phytogenic feed additive, a medium-chain fatty acid, an organic acid, or a combination thereof.

Embodiment 2 provides the composition of Embodiment 1, wherein the functional soybean meal comprises functional soybean meal particles, wherein each of the functional soybean meal particles comprises both the soybean meal and the functional additive.

Embodiment 3 provides the composition of Embodiment 2, wherein each of the functional soybean meal particles comprises both the soybean meal and the functional additive within the particle.

Embodiment 4 provides the composition of any one of Embodiments 2-3, wherein each of the functional soybean meal particles comprises an approximately equal concentration of the soybean meal and an approximately equal concentration of the functional additive.

Embodiment 5 provides the composition of any one of Embodiments 2-4, wherein the soybean meal and the functional additive are homogeneously distributed in each functional soybean meal particle.

Embodiment 6 provides the composition of any one of Embodiments 2-5, wherein the functional soybean meal is substantially free of particles that include the functional additive but that are free of the soybean meal, and the functional soybean meal is substantially free of particles that include the soybean meal but are free of the functional additive.

Embodiment 7 provides the composition of any one of Embodiments 1-6, wherein the soybean meal comprises ground soybean cake, ground soybean chips, ground soybean flakes, or a combination thereof.

Embodiment 8 provides the composition of any one of Embodiments 1-7, wherein the soybean meal is 50 wt% to 99.999 wt% of the functional soybean meal.

Embodiment 9 provides the composition of any one of Embodiments 1-8, wherein the soybean meal is 75 wt% to 99.99 wt% of the functional soybean meal.

Embodiment 10 provides the composition of any one of Embodiments 1-9, wherein the soybean meal is 85 wt% to 99.99 wt% of the functional soybean meal.

Embodiment 11 provides the composition of any one of Embodiments 1-10, wherein the phytogenic feed additive, the medium-chain fatty acid, and the organic acid, are plant-derived.

Embodiment 12 provides the composition of any one of Embodiments 1-11, wherein 100 wt% of the functional feed additive is plant derived.

Embodiment 13 provides the composition of any one of Embodiments 1-12, wherein the phytogenic feed additive, the medium-chain fatty acid, the organic acid, or a combination thereof, comprises a plant-derived antimicrobial agent.

Embodiment 14 provides the composition of any one of Embodiments 1-13, wherein the phytogenic feed additive, the medium-chain fatty acid, the organic acid, or a combination thereof, comprises an antioxidant, prebiotic, probiotic, ionophore, or a combination thereof.

Embodiment 15 provides the composition of any one of Embodiments 1-14, wherein the functional additive comprises the phytogenic feed additive.

Embodiment 16 provides the composition of Embodiment 15, wherein the phytogenic feed additive comprises a plant-extract.

Embodiment 17 provides the composition of any one of Embodiments 15-16, wherein the phytogenic feed additive comprises a plant-derived essential oil, a saponin, a flavonoid, a mucilage, a tannin, or a combination thereof.

Embodiment 18 provides the composition of any one of Embodiments 15-17, wherein the phytogenic feed additive comprises a plant-derived essential oil derived from thyme (thymus vulgaris 1., lamiaceae), ajowan (trachyspermum ammi), oregano (origanum syriacum), clove (syzygium aromaticum), lavender (lavandula angustifólia and/or lavandula stoechas), eucalyptus (eucalyptus citriodora, eucalyptus radiata, eucalyptus globulus and/or eucalyptus polybractea), marjoran (origanum majorana), peppermint (mentha arvenses and/or mentha piperita), ho wood (cinnamonum camphora), palma rosa (cymbopogon martini), cinnamon (cinnamonum verum, cinnamon cassia and/or cinnamon loureiroi), cumin (cuminum cyminum), niaouli (melaleuca quinquenervia), tea tree (leptospermum petersonii), lemon grass (cymbopogon flexuosus and/or cymbopogon citratus), lemon balm (melissa officinalis), citronella (cymbopogan winterianus), myrtus (myrtus communis), rosemary (rosmarinus officialis), pennyroyal (mentha polegium), bay (laurus nobilis), basil (ocimum basilicum), anis (pimpinella anisum), star aniseed (illicium verum), fennel (foeniculum vulgare), rose geranium (pelargonium graveolens), ylang ylang (cananga adorate), chamomile (chamaemelum nobile), birch (betula alleghaniensis and/or betula lenta), african basil (ocimum gratissimum), coriander (coriandrum sativum), bitter orange (citrus aurantium), silver fir (abies alba), hop (humulus lupulus), marijuana (cannabis sativa), ginger (zingiber officiale), myrrh (commiphora myrrha), black pepper (piper nigrum), bergamot orange (citrus bergamia), lemon (citrus limon, citrus aurantifolia, citrus reticulata and/or citrus bergamia), angelica (angelia archangelica), patchouli (pogostemon cablin), damask rose (rosa damascena), celery (apium graveolens), garlic (allium sativum), cedar (cedrus deodora), or a combination thereof.

Embodiment 19 provides the composition of any one of Embodiments 15-18, wherein the phytogenic feed additive comprises an aromatic phenol, terpenic alcohol, sesquiterpenic alcohol, aromatic aldehyde, terpenic aldehyde, terpenic ketone, terpenic oxide, methyl ether phenol, terpenic sterol, terpene, sesquiterpene, lactone, coumarin, a phthalide, or a combination thereof.

Embodiment 20 provides the composition of any one of Embodiments 15-19, wherein the phytogenic feed additive is 0.001 wt% to 5 wt% of the functional soybean meal.

Embodiment 21 provides the composition of any one of Embodiments 15-20, wherein the phytogenic feed additive is 0.01 wt% to 2 wt% of the functional soybean meal.

Embodiment 22 provides the composition of any one of Embodiments 1-21, wherein the functional additive comprises the medium-chain fatty acid.

Embodiment 23 provides the composition of Embodiment 22, wherein the medium-chain fatty acid is a C₆-C₁₂ saturated monocarboxylic acid.

Embodiment 24 provides the composition of any one of Embodiments 22-23, wherein the medium-chain fatty acid comprises caproic acid, caprylic acid, capric acid, lauric acid, or a combination thereof.

Embodiment 25 provides the composition of any one of Embodiments 22-24, wherein the medium-chain fatty acid is 0.001 wt% to 10 wt% of the functional soybean meal.

Embodiment 26 provides the composition of any one of Embodiments 22-25, wherein the medium-chain fatty acid is 0.01 wt% to 5 wt% of the functional soybean meal.

Embodiment 27 provides the composition of any one of Embodiments 1-26, wherein the functional additive comprises an organic acid.

Embodiment 28 provides the composition of Embodiment 27, wherein the organic acid is not a medium-chain fatty acid.

Embodiment 29 provides the composition of any one of Embodiments 27-28, wherein the organic acid comprises C₂-C₆ saturated or unsaturated mono- or di-carboxylic acid optionally substituted with one or more hydroxyl groups.

Embodiment 30 provides the composition of any one of Embodiments 27-29, wherein the organic acid comprises lactic acid, benzoic acid, fumaric acid, acetic acid, propionic acid, butyric acid, citric acid, malic acid, sorbic acid, formic acid, or a combination thereof.

Embodiment 31 provides the composition of any one of Embodiments 27-30, wherein the organic acid is 0.001 wt% to 30 wt% of the functional soybean meal.

Embodiment 32 provides the composition of any one of Embodiments 27-31, wherein the organic acid is 0.01 wt% to 15 wt% of the functional soybean meal.

Embodiment 33 provides the composition of any one of Embodiments 1-32, wherein the functional additive is 0.001 wt% to 50 wt% of the functional soybean meal.

Embodiment 34 provides the composition of any one of Embodiments 1-33, wherein the functional additive is 0.01 wt% to 25 wt% of the functional soybean meal.

Embodiment 35 provides the composition of any one of Embodiments 1-34, wherein the functional additive is 0.01 wt% to 15 wt% of the functional soybean meal.

Embodiment 36 provides the composition of any one of Embodiments 1-35, wherein the functional soybean meal is substantially free of non-plant-derived antimicrobials.

Embodiment 37 provides the composition of any one of Embodiments 1-36, wherein the functional soybean meal is substantially free of non-plant-derived antibiotics.

Embodiment 38 provides the composition of any one of Embodiments 1-37, wherein the composition is substantially free of non-plant-derived antimicrobials.

Embodiment 39 provides the composition of any one of Embodiments 1-38, wherein the composition is substantially free of non-plant-derived antibiotics.

Embodiment 40 provides the composition of any one of Embodiments 1-39, wherein the functional soybean meal is 0.01 wt% to 100 wt% of the composition.

Embodiment 41 provides the composition of any one of Embodiments 1-40, wherein the composition is the animal feed.

Embodiment 42 provides the composition of any one of Embodiments 1-41, wherein the animal feed is a complete feed.

Embodiment 43 provides the composition of any one of Embodiments 1-42, wherein the functional soybean meal is 0.1 wt% to 50 wt% of the animal feed.

Embodiment 44 provides the composition of any one of Embodiments 1-43, wherein the functional soybean meal is 1 wt% to 20 wt% of the animal feed.

Embodiment 45 provides the composition of any one of Embodiments 1-44, wherein the composition is the animal feed product.

Embodiment 46 provides the composition of any one of Embodiments 1-45, wherein the animal feed product is for forming the animal feed by combining the animal feed product with a base animal feed to form the animal feed.

Embodiment 47 provides the composition of any one of Embodiments 1-46, wherein the animal feed product is formulated to form the animal feed by combining with a base animal feed such that the animal feed product is less than 50 wt% of the animal feed.

Embodiment 48 provides the composition of any one of Embodiments 1-47, wherein the animal feed product is formulated to form the animal feed by combining with a base animal feed such that the animal feed product is less than 20 wt% of the animal feed.

Embodiment 49 provides the composition of any one of Embodiments 1-48, wherein the animal feed product is formulated to form the animal feed by combining with a base animal feed such that the animal feed product is 1 wt% to 20 wt% of the animal feed.

Embodiment 50 provides the composition of any one of Embodiments 1-49, wherein the animal feed product comprises a premix, a concentrate, a base mix, a supplement, a top dress, or a combination thereof.

Embodiment 51 provides the composition of any one of Embodiments 1-50, wherein the animal feed product comprises a premix, a concentrate, a supplement, a top dress, or a combination thereof.

Embodiment 52 provides the composition of Embodiment 51, wherein the functional soybean meal is 1 wt% to 100 wt% of the animal feed product.

Embodiment 53 provides the composition of any one of Embodiments 51-52, wherein the functional soybean meal is 50 wt% to 100 wt% of the animal feed product.

Embodiment 54 provides the composition of any one of Embodiments 1-53, wherein the animal feed provides digestive enhancement, improved palatability, improved nutrient utilization, improved gut health, reduction of bacterial pathogenicity, improvement in performance, improved well-being, reduced inflammation, overall improved health, overall improvement in performance, or a combination thereof, as compared to a corresponding animal feed that is free of the functional soybean material.

Embodiment 55 provides the composition of any one of Embodiments 1-54, wherein the animal feed, the animal feed product, or a combination thereof, further comprises vitamins, trace minerals, edible plant materials, grain, corn, soy, rice, wheat, or a combination thereof.

Embodiment 56 provides an animal feed product that is a premix, a base mix, a concentrate, a supplement, or a top dress, for forming an animal feed, the feed product comprising:

a functional soybean meal that is 50 wt% to 100 wt% of the feed product, the functional soybean meal comprising
soybean meal that is 75 wt% to 99.99 wt% of the functional soybean meal; and
a functional additive comprising a phytogenic feed additive, a medium-chain fatty acid, an organic acid, or a combination thereof, wherein the functional additive is 0.01 wt% to 25 wt% of the functional soybean meal;
wherein
the animal feed product is formulated to form the animal feed by combining with a base animal feed such that the animal feed product is 30 wt% or less of the animal feed,
the functional soybean meal comprises functional soybean meal particles that each comprise both the soybean meal and the functional additive within the particle, and
the functional soybean meal is substantially free of non-plant-derived antimicrobials.

Embodiment 57 provides an animal feed comprising:
a base animal feed; and
a functional soybean meal that is 1 wt% to 20 wt% of the animal feed, the functional soybean meal comprising
   soybean meal that is 75 wt% to 99.99 wt% of the functional soybean meal; and
   a functional additive comprising a phytogenic feed additive, a medium-chain fatty acid, an organic acid, or a combination thereof, wherein the functional additive is 0.01 wt% to 25 wt% of the functional soybean meal;
wherein the functional soybean meal comprises functional soybean meal particles that each comprise both the soybean meal and the functional additive within the particle, and the animal feed is substantially free of non-plant-derived antimicrobials.

Embodiment 58 provides a method of feeding an animal, the method comprising: feeding the composition that is an animal feed or an animal feed product of any one of Embodiments 1-57 to an animal.

Embodiment 59 provides a method of feeding an animal, the method comprising:
feeding the animal a functional soybean meal, the functional soybean meal comprising
   soybean meal that is 75 wt% to 99.99 wt% of the functional soybean meal; and
   a functional additive comprising a phytogenic feed additive, a medium-chain fatty acid, an organic acid, or a combination thereof, wherein the functional additive is 0.01 wt% to 25 wt% of the functional soybean meal;
wherein the functional soybean meal comprises functional soybean meal particles that each comprise both the soybean meal and the functional additive within the particle.

Embodiment 60 provides the method of any one of Embodiments 58-59, wherein the method comprises feeding the animal a daily feed ration comprising the functional soybean meal, wherein the daily feed ration is fed to the animal on most days or on all days.

Embodiment 61 provides the method of any one of Embodiments 58-60, wherein the method further comprises combining the functional soybean meal with a base animal feed to form the animal feed.

Embodiment 62 provides the method of any one of Embodiments 58-61, wherein the method comprises feeding the animal a diet that does not include non-plant-derived antimicrobials.

Embodiment 63 provides the method of any one of Embodiments 58-62, wherein the method comprises feeding the animal a diet that does not include non-plant-derived antibiotics.

Embodiment 64 provides the method of any one of Embodiments 58-63, wherein the method provides digestive enhancement, improved palatability, improved nutrient utilization, improved gut health, reduction of bacterial pathogenicity, improvement in performance, improved well-being, reduced inflammation, overall improved health, overall improvement in performance, or a combination thereof, as compared to a corresponding method free of feeding the animal the functional soybean meal.

Embodiment 65 provides a method of feeding an animal comprising:
feeding the animal an animal feed comprising
   a base animal feed; and
   a functional soybean meal that is 1 wt% to 20 wt% of the animal feed, the functional soybean meal comprising
      soybean meal that is 75 wt% to 99.99 wt% of the functional soybean meal; and
      a functional additive comprising a phytogenic feed additive, a medium-chain fatty acid, an organic acid, or a combination thereof, wherein the functional additive is 0.01 wt% to 25 wt% of the functional soybean meal;
wherein the functional soybean meal comprises functional soybean meal particles that each comprise both the soybean meal and the functional additive within the particle, and wherein the animal feed is substantially free of non-plant-derived antimicrobials.

Embodiment 66 provides a method of making the composition that is an animal feed or an animal feed product of any one of Embodiments 1-57, the method comprising: combining the soybean meal and the functional additives to form the functional soybean meal.

Embodiment 67 provides the method of Embodiment 66, wherein the method comprises combining functional additive with the soybean meal during the milling of soybeans to form the soybean meal and prior to the drying of the soybean meal.

Embodiment 68 provides the method of any one of Embodiments 66-67, wherein combining the functional additive with the soybean meal during the milling of soybeans to form the soybean meal intimately mixes the soybean meal and the functional additive to form the particles of the functional soybean meal that each comprise both the soybean meal and the functional additive within the particle.

Embodiment 69 provides a method of making the composition of any one of Embodiments 1-57, the method comprising: combining functional soybean meal with a base animal feed to form the animal feed.

Embodiment 70 provides a method of making a functional soybean meal, the method comprising:

combining a functional additive with a soybean meal during the milling of soybeans to form the soybean meal and prior to the drying of the soybean meal, to form the functional soybean meal, wherein the functional soybean meal comprises
   the soybean meal that is 75 wt% to 99.99 wt% of the functional soybean meal, and
   the functional additive comprising a phytogenic feed additive, a medium-chain fatty acid, an organic acid, or a combination thereof, wherein the functional additive is 0.01 wt% to 25 wt% of the functional soybean meal;
wherein the functional soybean meal comprises functional soybean meal particles that each comprise both the soybean meal and the functional additive within the particle, and the functional soybean meal is substantially free of non-plant-derived antimicrobials.

Embodiment 71 provides the composition or method of any one or any combination of Embodiments 1-70 optionally configured such that all elements or options recited are available to use or select from.

1. A composition that is an animal feed or an animal feed product for forming the animal feed, the composition comprising:
a functional soybean meal comprising
soybean meal; and
a functional additive comprising a phytogenic feed additive, a medium-chain fatty acid, an organic acid, or a combination thereof.

2. The composition of claim 1, wherein the functional soybean meal comprises functional soybean meal particles, wherein each of the functional soybean meal particles comprises both the soybean meal and the functional additive.

3. The composition of claim 1, wherein the soybean meal is 85 wt% to 99.99 wt% of the functional soybean meal.

4. The composition of claim 1, wherein 100 wt% of the functional feed additive is plant derived.

5. The composition of claim 1, wherein the functional additive comprises the phytogenic feed additive, wherein the phytogenic feed additive comprises a plant-extract.

6. The composition of claim 5, wherein the phytogenic feed additive comprises a plant-derived essential oil, a saponin, a flavonoid, a mucilage, a tannin, or a combination thereof.

7. The composition of claim 1, wherein the functional additive comprises the medium-chain fatty acid, wherein the medium-chain fatty acid is a C₆-C₁₂ saturated monocarboxylic acid.

8. The composition of claim 7, wherein the medium-chain fatty acid comprises caproic acid, caprylic acid, capric acid, lauric acid, or a combination thereof.

9. The composition of claim 1, wherein the functional additive comprises an organic acid, wherein the organic acid comprises C₂-C₆ saturated or unsaturated mono- or di-carboxylic acid optionally substituted with one or more hydroxyl groups.

10. The composition of claim 9, wherein the organic acid comprises lactic acid, benzoic acid, fumaric acid, acetic acid, propionic acid, butyric acid, citric acid, malic acid, sorbic acid, formic acid, or a combination thereof.

11. The composition of claim 1, wherein the functional additive is 0.01 wt% to 15 wt% of the functional soybean meal.

12. The composition of claim 1, wherein the composition is substantially free of non-plant-derived antimicrobials, antibiotics, or a combination thereof.

13. The composition of claim 1, wherein the functional soybean meal is 1 wt% to 20 wt% of the animal feed.

14. The composition of claim 1, wherein the animal feed product is for forming the animal feed by combining the animal feed product with a base animal feed to form the animal feed, wherein the animal feed product is formulated to form the animal feed by combining with a base animal feed such that the animal feed product is 1 wt% to 20 wt% of the animal feed.

15. An animal feed product that is a premix, a base mix, a concentrate, a supplement, or a top dress, for forming an animal feed, the feed product comprising:
a functional soybean meal that is 50 wt% to 100 wt% of the feed product, the functional soybean meal comprising
soybean meal that is 75 wt% to 99.99 wt% of the functional soybean meal; and
a functional additive comprising a phytogenic feed additive, a medium-chain fatty acid, an organic acid, or a combination thereof, wherein the functional additive is 0.01 wt% to 25 wt% of the functional soybean meal; wherein
the animal feed product is formulated to form the animal feed by combining with a base animal feed such that the animal feed product is 30 wt% or less of the animal feed,
the functional soybean meal comprises functional soybean meal particles that each comprise both the soybean meal and the functional additive within the particle, and
the functional soybean meal is substantially free of non-plant-derived antimicrobials.

16. An animal feed comprising:
a base animal feed; and
a functional soybean meal that is 1 wt% to 20 wt% of the animal feed, the functional soybean meal comprising
soybean meal that is 75 wt% to 99.99 wt% of the functional soybean meal; and
a functional additive comprising a phytogenic feed additive, a medium-chain fatty acid, an organic acid, or a combination thereof, wherein the functional additive is 0.01 wt% to 25 wt% of the functional soybean meal;
wherein the functional soybean meal comprises functional soybean meal particles that each comprise both the soybean meal and the functional additive within the particle, the animal feed is substantially free of non-plant-derived antimicrobials, and the animal feed is a complete feed.

17. A method of feeding an animal, the method comprising:
feeding the composition that is an animal feed or an animal feed product of claim 1 to an animal.

18. A method of making the composition that is an animal feed or an animal feed product of claim 1, the method comprising:
combining the soybean meal and the functional additives to form the functional soybean meal.

19. The method of claim 18, wherein the method comprises
combining functional additive with the soybean meal during the milling of soybeans to form the soybean meal and prior to the drying of the soybean meal.

20. A method of making the composition of claim 1, the method comprising:
combining functional soybean meal with a base animal feed to form the animal feed.
